(19) United States
(12) Patent Application Publication
(10) Pub. No.: US 2026/0257232 A1
(43) Pub. Date: Sep. 3, 2026

(54) METHOD FOR CLEANING A SEPARATOR

(71) Applicant: GEA WESTFALIA SEPARATOR GROUP GMBH, Oelde (DE)

(72) Inventors: Jürgen TEIGELER, Oelde (DE); Daniel DEMPKI, Oelde (DE); Bernd SPIEKERMEIER, Oelde (DE)

(21) Appl. No.: 19/113,175

(22) PCT Filed: Sep. 13, 2023
(86) PCT No.: PCT/EP2023/075085

§ 371 Date: Mar. 19, 2025

(30) Foreign Application Priority Data
Sep. 20, 2022 (DE) 10 2022 124 097.5

(51) Int. Cl. B04B 15/06; B04B 1/08; B04B 1/14

(52) U.S. Cl. CPC B04B 15/06; B04B 1/08; B04B 1/14

(57) ABSTRACT

A method for centrifugally processing a flowable product with a separator and for rinsing and/or CIP cleaning the separator is provided. The separator has a rotatable drum and a product flow path for a flowable product to be processed in a centrifugal field in the drum. Product flows along the product flow path during the centrifugal processing in a product flow direction. The centrifugal processing of a product is interrupted and rinsing or CIP cleaning of at least one part of the product paths of the drum of the separator in the product flow direction is performed and rinsing or CIP cleaning of at least one part of the product paths of the drum entirely or partially opposite the product flow direction is performed. The centrifugally processing the product is then resumed.

### BACKGROUND AND SUMMARY OF THE INVENTION

Exemplary embodiments of the invention relate to a method for centrifugally processing a flowable product with a separator and for rinsing and/or CIP cleaning the separator, as well as to a separator for carrying out this method.

A disk centrifuge or separator is used to separate suspensions into phases of different densities in the centrifugal field of a rotating drum. With a self-cleaning clarifier, for example, the suspension is separated into a lighter phase (usually a free-flowing or liquid phase) and a heavier phase (e.g., a solid phase) in the centrifugal chamber of the drum.

The lighter phase is discharged from the drum via a liquid discharge—e.g., via a gripper or a paring disk—while the solids phase is discharged discontinuously during operation through closable and openable discharge openings on the outer circumference of the drum. On the one hand, these discharges remove the solids from the centrifugal chamber of the drum and, on the other hand, the flow generated during a discharge ensures that deposits are flushed out of the disk stack and the rotating drum.

In a nozzle separator, the heavy phase (e.g., a solid phase) is continuously discharged through nozzles on the outer circumference of the drum.

When clarifying products such as coffee extract, for example, which adhere to the surfaces of the separating disks and the drum, the problem arises that the adhering residues can only be removed from the separating disks or cleaned off with considerable effort.

When processing such products or suspensions to be separated centrifugally, which tend to stick or clog the disk stack of a separator or the drum of the separator or can lead to such an effect, a so-called “complete emptying” and a subsequent “rinsing” are therefore usually carried out at regular intervals—in particular during a “separating” operating phase between two solids emptying operations—in which product deposits in particular are to be rinsed out of the disk stack.

During such a complete emptying, the product feed is interrupted, the product is displaced from the drum with rinsing liquid and the collected solids are completely emptied from the separator together with the rinsing liquid in the drum. Complete emptying can take place at the operating speed of the centrifuge or at a reduced speed.

Such a complete emptying of the separator takes place in particular when the inlet is closed, so that the drum can be completely emptied. A rinsing liquid, such as hot water, is then flushed through the drum (inlet, distributor, disk stack, gripper—also known as the paring disk- and outlet) instead of the suspension to be separated.

In addition to this rinsing, further rinsing emptying operations can optionally be carried out, i.e., the emptying openings of the drum for emptying the solids are briefly opened from a closed state after the drum has been filled with rinsing liquid, so that the rinsing liquid from the disk stack and the solids chamber flows through the emptying openings in an intermittent manner in order to achieve a more intensive cleaning effect.

In this way, product deposits that have settled on the surfaces of the separating disks and the drum are removed so that the subsequent separation process is not impaired by these deposits. The path of the rinsing liquid through the separator in the “rinsing” operating mode is identical to the path of the product or suspension to be processed.

In the area of the distributor and the emptying openings, the rinsing liquid flows during rinsing essentially in the direction of the centrifugal force, in the area of the disk stack essentially against the direction of the centrifugal force. The rinsing liquid is introduced when the inlet valve of the suspension supply line is closed and the cleaning fluid valve of the rinsing liquid supply line is open. The rinsing liquid can be drained from the drum via the light phase drain, for example. If mixing of the rinsing liquid with the light phase is not desired, a separate drain must be created using suitable valves.

In addition to the capacity of the feed pump, the flow of the suspension to be separated or the rinsing liquid is determined by the different radii on which the feed and discharge into and out of the drum take place. The radius at which the outlet is located is larger than the radius at which the inlet is located, resulting in a pressure gradient in the rotating drum, which supports the flow.

At the end of production, i.e., after several “separating” and “rinsing” operating phases, a “cleaning” operating phase can follow, e.g., for CIP cleaning (“cleaning in place”) with appropriate cleaning liquids, such as acids, alkalis, and water, to clean all surfaces in contact with the product even more intensively in accordance with the hygiene requirements of the food industry, for example, than is possible by rinsing during the “rinsing” operating phase. Various cleaning liquids, such as alkalis and acids, are used as cleaning agents and passed through the separator in the same way as already described for the suspension or rinsing liquid.

In contrast to the rinsing liquid (often water), the cleaning liquids should not come into contact with the product to be separated, the suspension, or the separated phases. Appropriate valves in the inlet and outlet lines ensure strict separation between the cleaning agents and the suspension or the separated phases.

EP 2 628 545 A1 shows a CIP system for a separator in which the cleaning liquid is fed from a storage tank to the inlet of the separator by means of a pump and the cleaning liquid emerging from the liquid outlets of the separator is fed back into the storage tank.

DE 10 2020 104 990 A1 states that the cleaning liquid flows through the product path during CIP cleaning.

DE 10 2017 111 672 A1 describes that a change in the speed change dn after the time dt-dn/dt-during emptying can be an indication of impurities in the drum.

A disadvantage of the solutions from the prior art is that the separator is not always adequately cleaned in the event of stubborn contamination, such as can occur during the centrifugal processing of coffee extract with a self-emptying separator. Furthermore, the productivity of the separator is impaired by the rinsing and/or CIP cleaning process according to the prior art.

Based on the prior art described at the beginning, exemplary embodiments of the invention are directed to an improved method for rinsing and/or CIP cleaning a self-emptying separator for the continuous processing of suspensions in which there is a risk that the suspensions may become contaminated during the centrifugal cleaning process.

The suspension can become contaminated or even clogged in the disk stack and/or the centrifugal chamber during processing.

Accordingly, a method is provided for centrifugally processing a flowable product with a separator and for rinsing and/or CIP cleaning the separator, wherein the separator comprises a rotatable drum and a product flow path for a flowable product to be processed in a centrifugal field in the drum, wherein the product flows through the product flow path in a product flow direction during the centrifugal processing, wherein the method comprises the following steps of:
100) providing the separator;
200) carrying out centrifugal processing of a product,
300) interrupting centrifugal processing, and alternately carrying out
a) rinsing or CIP cleaning of at least one part of the product paths of the drum of the separator in the product flow direction, and
b) rinsing or CIP cleaning of at least one part of the product paths of the drum entirely or partially in the opposite direction to the product flow direction, and preferably
400) resuming the step 200) of centrifugally processing the product.

This creates a rinsing and/or cleaning process to supplement centrifugal processing, which achieves significantly improved cleaning of the contaminated surfaces of the drum and its internals thanks to the different flow directions.

In a particularly preferred embodiment variant of the invention, it is provided that during rinsing or CIP cleaning of the product paths of the drum of the separator in the product flow direction, a cleaning fluid is fed into the drum through the inlet and is respectively fed out of the drum through the open solids discharge openings, and that during rinsing or CIP cleaning of the product paths of the drum of the separator partially against the product flow direction, a cleaning fluid is fed into the drum through the discharge and is respectively fed out of the drum through open solids discharge openings. This type of cleaning is usually particularly effective.

The method is particularly suitable for a separator which also has the following: a centrifugal chamber, which is formed within the drum, an inlet into the centrifugal chamber, wherein a product feed line and a first rinsing and/or CIP feed line open into the inlet, wherein an inlet valve VS is connected into the product feed line and a cleaning fluid valve is connected into the first CIP feed line; at least one first outlet for a first product phase, wherein the first outlet opens into a drain line; at least one second continuously open or discontinuously openable and reclosable outlet for a second solids-type product phase, a controllable cleaning fluid valve which is connected into a second CIP feed line, which opens into the outlet line upstream of an outlet valve which is connected into the drain line.

This enables higher flow rates of the rinsing or CIP cleaning agent, particularly in the area of the disk stack of the separator, which results in significantly improved cleaning of the contaminated surfaces of the drum and its internals, particularly in the area of the disk stack and the centrifugal chamber.

According to an alternative, it may be provided that the second outlet for the second product phase has one or more permanently open nozzles. Alternatively, however, it may also be provided that the second outlet for the second product phase has one or more closable and openable solids discharge openings, to which one or more closing elements for discontinuously opening and closing the solids discharge openings are assigned, wherein at least one control system is provided for moving the closing element or the closing elements. Combinations of these second outlets are also conceivable (on the one hand nozzles and on the other hand closable solids discharge openings).

Rinsing against the product flow direction at least once or preferably several times in accordance with the invention can therefore be carried out both with nozzle separators and with self-emptying separators. In the latter, the emptying openings must be opened for this purpose; in nozzle separators, this is already provided by the nozzle openings.

It is preferably provided that the separator further comprises a control device, which is provided with a control program with which the method for centrifugally processing a flowable product with a separator and for rinsing and/or CIP cleaning of the separator is controlled. The control device can be arranged directly on the separator or partly on the separator and partly at another location. Cloud services can also be integrated into the control system or the implementation of the control device.

In a further particularly preferred embodiment variant of the invention, it is provided that step 300) is carried out repeatedly for each cleaning process. This achieves particularly thorough cleaning. After step 300), centrifugal processing can preferably be continued in a step 400). It is then possible for step 300) to be carried out again once or several times, optionally at intervals. Steps 200) and 300) can thus also be run through repeatedly in the manner of a loop.

According to another particularly preferred embodiment variant, it may be provided that the rinsing and/or CIP cleaning process takes place in step 300) after the inlet valve has been closed at the end of step 200) and the solids discharge openings for the solids SP have been permanently opened or are open. This creates the preconditions for rinsing or CIP cleaning in the product flow direction by means of a simple control process.

Furthermore, according to a further particularly preferred specification of the invention, it may be provided that after the drum has been completely emptied, during which the drum has lost speed, it is waited until the drum has reached a higher speed again, in particular the operating speed, wherein the cleaning fluid valve is then opened for a period of time, preferably for a few seconds, and a rinsing or CIP cleaning fluid is fed through the first CIP feed line into the feed line and further into the inlet pipe into the drum, wherein the drum remains open. In this way, rinsing or CIP cleaning can be initiated in the product flow direction by a simple control process.

In a further particularly preferred embodiment variant of the invention, it is provided that the rinsing or CIP cleaning liquid flows through the central inlet pipe, the distribution channels and a first, in particular a lower region of the drum, from where it leaves the drum again through the open solids discharge openings for solids. This rinses or cleans the central inlet pipe, the distribution channels and the first, in particular lower, area of the drum in a targeted manner.

Furthermore, according to a further, particularly preferred embodiment variant, it may be provided that after a period of time, preferably a few seconds, the rinsing process, during which the drum has lost speed again, is stopped by closing the cleaning fluid valve in the first CIP feed line. This also stops the rinsing or CIP cleaning in the product flow direction by means of a simple control process.

According to a further particularly preferred embodiment variant, it may be provided that an increase in speed to the operating speed is waited for and then a further cleaning fluid valve is opened for a period of time, preferably a few seconds, which is connected into a second CIP feed line which opens into the drain line upstream of a drain valve which is connected into the drain line, and that a rinsing or CIP cleaning fluid is fed into the drum through the second CIP feed line and drain line.

In this connection, according to a further particularly preferred embodiment variant of the invention, it may be provided that the rinsing or CIP cleaning liquid flows through the central drain line, a paring disk, a separating disk stack, and a second, preferably upper, region of the drum in order to leave the drum again through the open solids discharge openings for solids SP. As a result, the central drain line, the paring disk, the separating disk stack and the second, preferably upper, area of the drum are cleaned in a targeted manner.

Furthermore, according to a further particularly preferred specification of the invention, it may be provided that after a period of time, preferably a few seconds, the rinsing and cleaning process, during which the drum has lost speed, is stopped by closing the cleaning fluid valve VSF2. This also stops the rinsing or CIP cleaning against the product flow direction by means of a simple control process.

In a further particularly preferred embodiment variant of the invention, it is provided that the flow during rinsing or CIP cleaning of the separating disk stack and the upper area of the drum is not against the centrifugal force, but essentially in the direction of the centrifugal force, contrary to the product flow direction. This results in a more intensive flow, i.e., an increased throughput (volume/time) of the rinsing or CIP cleaning fluid compared to the prior art, which enables a higher flow rate of the rinsing or cleaning fluid. This higher flow rate results in significantly improved cleaning of the contaminated surfaces of the drum and its internals.

Furthermore, according to a further, particularly preferred embodiment variant, it may be provided that the rinsing or CIP cleaning liquid preferably has a temperature of between 40° C. and 90° C. and is particularly preferably heated to a temperature of between 50° C. and 70° C. This results in particularly intensive cleaning of the drum and its internals.

According to another particularly preferred embodiment variant, it may be possible to dispense with rinsing emptying of the drum during the rinsing or CIP cleaning process. This results in an advantageous increase in the productivity of the separator, as the centrifugal separation process cannot take place during rinsing emptying.

According to a further particularly preferred specification of the invention, it may also be provided that the control program is used to evaluate characteristic measured values, in particular the value of the speed drop Δn and the speed of the speed drop Δn/Δt during drum emptying, wherein the evaluation of this data in the control system is used to infer the degree of contamination of the separating disk stack or the region of the centrifugal chamber in which the solid SP collects (see DE102017111672A1). This allows a rinsing or CIP cleaning process to be carried out specifically according to the actual degree of soiling of the drum and its internals, which can save rinsing and/or CIP cleaning fluid and optimize operation overall.

In a further particularly preferred embodiment variant of the invention, it is provided that a number of rinsing or CIP cleaning processes are carried out, wherein a rinsing or cleaning process comprises forward and backward rinsing in each case if the measured values Δn and Δn/At indicate a defined degree of contamination. By repeating the rinsing or CIP cleaning process, the degree of soiling of the drum and its internals can be reduced in a targeted manner until the measured values indicate a cleaned drum.

Furthermore, according to a further particularly preferred specification of the invention, it may be provided that a CIP cleaning with cleaning liquids such as acids and alkalis is initiated if the rinsing process no longer results in sufficient cleaning. This advantageously reduces the consumption of CIP cleaning liquids.

Furthermore, according to a further particularly preferred specification of the invention, it may be provided that the separator is stopped and disassembled for mechanical cleaning if the measured values for speed drop Δn and the speed of the speed drop Δn/At during a drum emptying indicate that even the CIP cleaning has no longer achieved sufficient cleaning. As a result, disassembly for cleaning the separator is carried out as required and not after rigid maintenance cycles, which also makes a beneficial contribution to the above-mentioned savings and thus to increasing the productivity of the separator and reducing its operating costs.

The invention also provides the advantageous separator for carrying out the method according to one or more of the method claims, which has the features relating to the separator and preferably according to one or more further developments has the features relating to the separator of one or more of the further subclaims, in particular the control device, which is provided with a control program with which a method according to one of the claims relating to the method can be carried out and in particular also a controllable cleaning fluid valve, which is connected into a second CIP feed line, which opens into the discharge line upstream of a discharge valve, which is connected into the discharge line. With such a separator, which is extended by at least some valves compared to the prior art, the method can be carried out in a simple manner.

### BRIEF DESCRIPTION OF THE DRAWING FIGURES

In the following, the invention is described in more detail by means of an exemplary embodiment with reference to the figures, wherein:

FIG. 1a: shows a schematic, partially sectional representation of a separator according to the invention in a “separating” operating state;

FIG. 1b: shows a schematic, partially sectional representation of the separator from FIG. 1a in a “rinsing” operating state during a first rinsing process;

FIG. 1c: shows a schematic, partially sectional representation of the separator from FIG. 1a in a “rinsing” operating state during a second rinsing process;

FIG. 2: shows a speed-time diagram; and

FIG. 3: shows a schematic, partially sectional representation of a separator according to the prior art.

### DETAILED DESCRIPTION

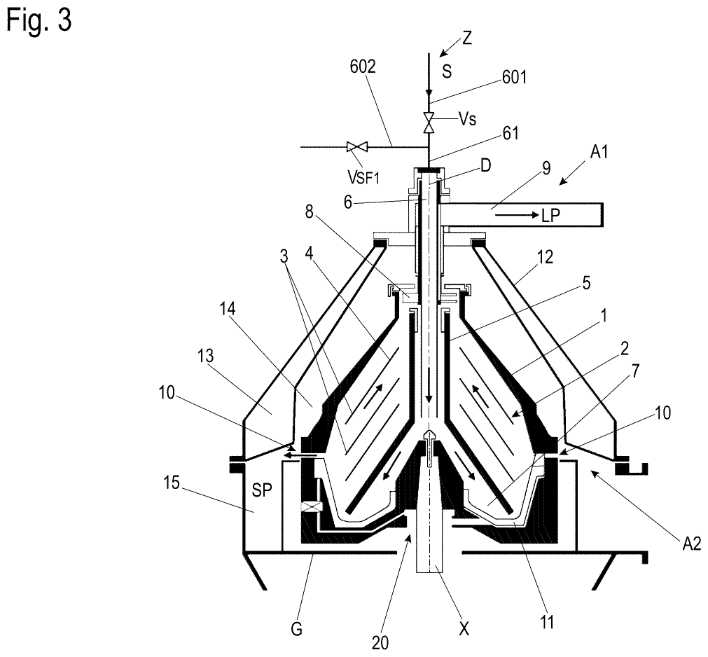

FIG. 3 shows a centrifuge that is designed as a separator with a rotatable drum 1. The separator and its drum 1 can be designed for continuous operation, i.e., the continuous and not batchwise processing of a product or a suspension S. In such processing, a suspension S to be processed is continuously fed during separation and separated into phases of different densities. For example, a liquid LP (light phase) can be separated or clarified as a product from a solid phase SP (heavier phase). Optionally, the liquid can be separated into two liquid phases LP1, LP2 of different densities. It is also possible to concentrate a solid phase SP as a valuable product from an initial product and separate it from a lighter phase LP. The one or more liquid phases are preferably discharged continuously. The solid phase can be discharged continuously (nozzle separator, not shown) or discontinuously (self-emptying separator).

The drum 1 can have a vertical axis of rotation D. It is mounted on a spindle X, which in turn can be rotated by a drive motor (not shown here). The spindle X can be supported and rotatably mounted on a frame G (not shown in full here). In the conically shaped drum 1, a separating disk stack 3 consisting of conical separating disks 4 is arranged in the (here exemplarily double-conical) drum interior, also referred to as the centrifugal chamber 2. The separating disks 4 are arranged on a distributor shaft 5 of a distributor. An inlet Z with an inlet pipe 6 projecting into the drum 1 serves to feed a product or suspension S to be processed into distributor channels 7 and from these into the centrifugal chamber 2.

The inlet Z also has a feed line 61 that opens into the inlet pipe 6. Either a product or suspension S to be processed or a CIP cleaning fluid such as a cleaning liquid can be fed into the drum through this feed line 61.

The path taken by the product or the suspension S and its individual phases into the drum 1, through the drum 1 and out of the drum 1 is also referred to in this document as the “product path” or “product flow direction”.

In the centrifugal chamber 2, the product to be processed or the suspension S to be processed is clarified of solids SP in the centrifugal field during the operation in which the drum 1 is rotated (and optionally an additional separation into two or more liquid phases LP1, LP2 of different density (not shown here)).

A first outlet A1 or several first outlets A1 for one or more liquid phase(s) LP1, LP2, which can, for example—but not necessarily—each be provided with paring disks 8 and can each open into a drain line 9, serve to discharge the at least one liquid phase LP1.

The solids-which can also form a still flowable solids phase SP—are discharged from the drum 1 through a second outlet A2, which comprises circumferentially distributed, radially extending solids discharge openings 10, preferably in the area of the largest radius/circumference of the drum, from which they are ejected to the outside.

A discontinuously operating or controllable closing mechanism is preferably assigned to the solids discharge openings 10. In this exemplary embodiment, this has a preferably fluid-actuated piston slide 11, which closes the solids discharge openings 10 in one position and releases or opens them in another position, so that solids can be discharged in this open state.

The centrifugally separated phases of the product or suspension S are thus discharged from the centrifugal chamber 2 through the first outlet-here with the paring disk 8—and the second outlet with the solids discharge openings 10, if these are opened discontinuously from time to time.

The drum 1 can be surrounded by a hood 12. This hood 12 is designed here purely as a double-walled example, so that a fluid can flow through this double-walled section 13 or it can also be filled with insulation.

A hood interior 14 is formed between the drum 1 and the hood 12, which can have or form a solids catcher 15 at the bottom, which serves to catch solids SP that are ejected from the drum 1.

The piston slide 11 is axially movable to a limited extent in (or on) the drum 1 and can be moved into an upper and a lower position. In FIG. 3, the piston slide 11 is shown in a lower position on the left half of the drum 1 and in an upper position on the right half of the drum 1. In the lower position, the solids discharge openings 10 are open, while in the upper position, the solids discharge openings 10 are closed, as shown in FIG. 3.

In FIG. 3, the piston slide 11 is arranged on the inside of the drum 1.

Alternatively, however, it can also be arranged on the outside of the drum 1 (not shown here), in which case it is axially movable to a limited extent in order to open and close the solids discharge openings.

However, the closing mechanism for the solids discharge openings 10 can also be actuated electromechanically (not shown here). Thus, a product or suspension S can be processed by separating the product or suspension S into different product phases in the centrifugal chamber 2. Alternatively, a “rinsing” or “cleaning” with a fluid, such as water, while completely emptying the drum 1 and/or a CIP cleaning (cleaning in place) with alkalis or acids of the product paths can be carried out, through the product paths of the drum 1 including the described inlets and outlets of the drum.

According to the prior art shown in FIG. 3, it may be provided that the feed line 61 has a product feed line 601 opening into the feed line 61 and a first rinsing and/or first CIP feed line 602 opening into the feed line 61. An inlet valve V_{S} or a cleaning fluid valve V_{SF1} can be connected in the product feed line 601 or in the CIP feed line 602, so that by opening and closing the respective inlet valve V_{S} or cleaning fluid valve V_{SF1}, either a CIP liquid can be fed through the CIP feed line 602 or a product or suspension S to be processed can be fed through the product feed line 601 into the feed line 61 and the inlet pipe 6 into the centrifugal chamber 2.

These valves and other controllable devices of the separator can be actuated with the aid of a control device (not shown here), with which the various valves and optionally other controllable devices of the separator can be actuated wirelessly or via a control line. This control device can have a memory and a microprocessor and can be connected to the controllable device(s) via a wired or wireless connection. Sensors or the like can also be connected to it. It can be connected directly or indirectly via intermediate devices to a display device and optionally to an input device. It may be provided with a program in order to be able to control the process run during centrifugal processing and rinsing/cleaning.

During CIP cleaning, the cleaning fluid valve V_{SF1} is opened and the inlet valve V_{S} is closed.

During CIP cleaning of the product paths of the drum 1 according to the prior art, the one or more cleaning fluids such as CIP cleaning fluids, in particular CIP fluids, flow into the centrifugal chamber 2 for CIP cleaning via the first CIP feed line 602 and the opened cleaning fluid valve V_{SF1} through the feed line 61 and the inlet pipe 6. From there, the respective CIP cleaning fluid flows out through the drain line 9 and the open solids discharge openings 10.

In this way, the product paths through which the product or its phases flow in a product flow direction during operation of the separator during centrifugal separation—in this case the feed line 61, the inlet pipe 6, the distributor 7, the centrifugal chamber 2, the disk stack 3, the paring disk 8, the drain line 9, and the solids discharge openings 10, and possibly also the solids catcher 15—can be subjected to cleaning, in particular CIP cleaning.

The piston slide 11 can be assigned an actuator system such as a control system 20 for moving the piston slide into an upper position (shown to the right of the axis of rotation D in FIG. 3) or a lower position (shown to the left of the axis of rotation in FIG. 3). This has control fluid paths through which a control fluid flows during operation.

When clarifying products, such as when clarifying a coffee extract, which adheres to the surfaces of the separating disks 4 and the drum 1, the problem arises that the adhering residues can only be cleaned off with considerable effort using the procedure described above. The invention therefore takes a different approach.

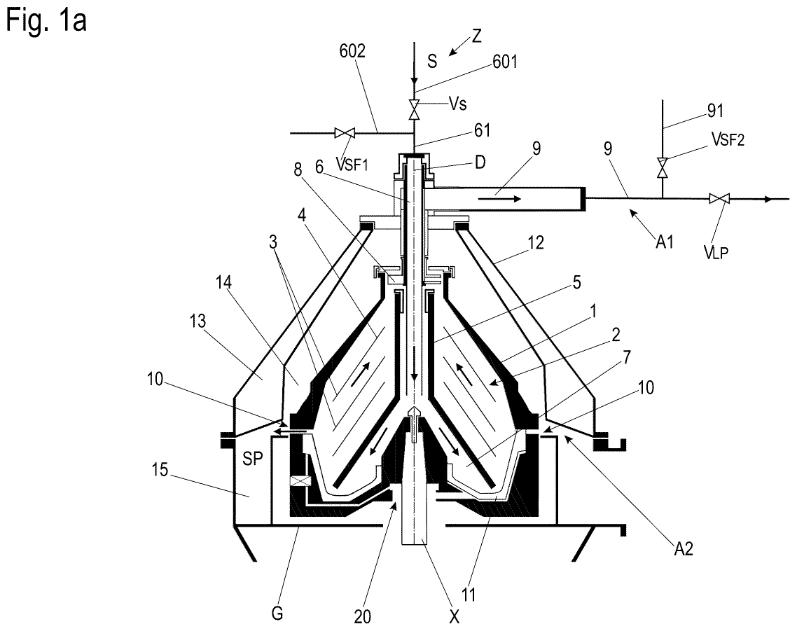

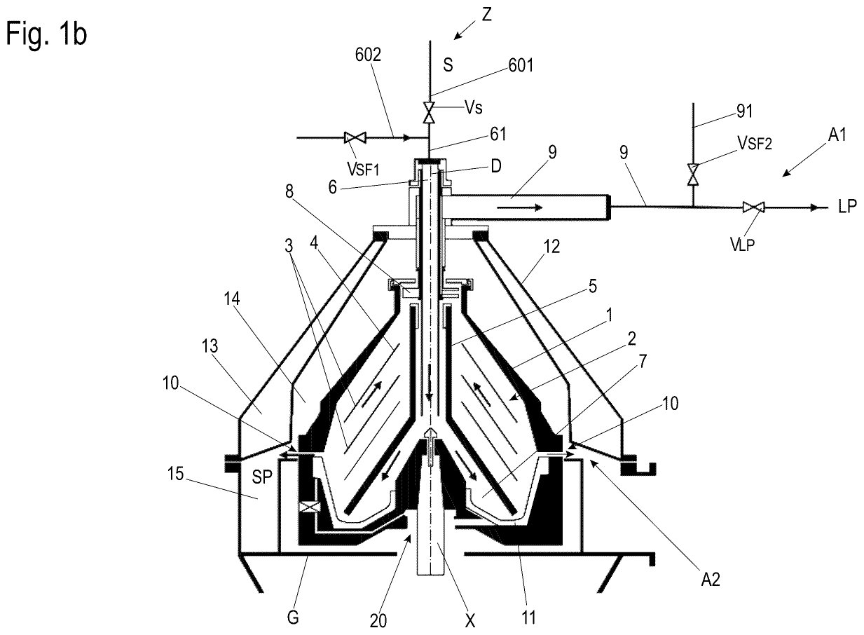

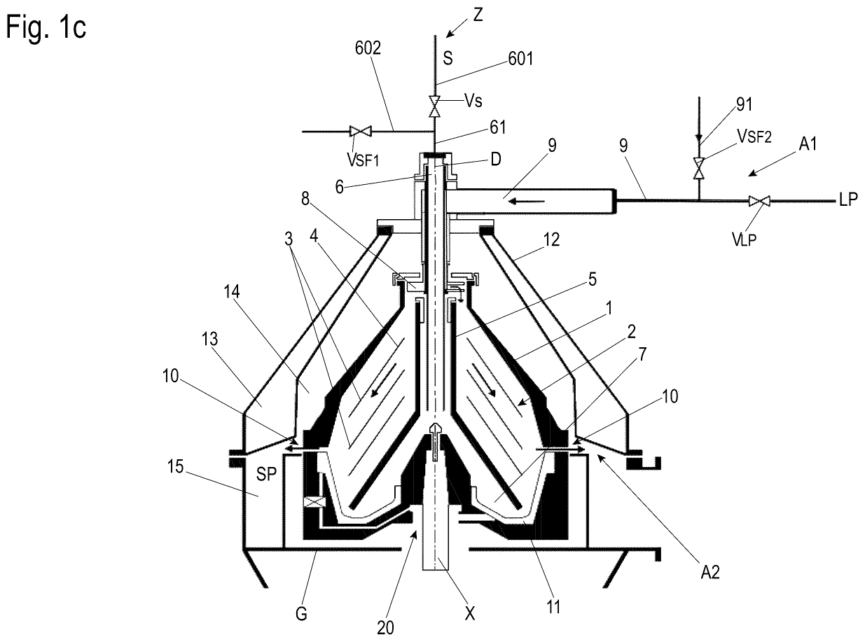

FIG. 1a shows a separator according to the invention in a “separating” operating state, which, in contrast to the prior art, can have an additional outlet valve V_{LP} in the drain line 9.

The drain line 9 can be opened or closed by the drain valve V_{LP}. Upstream—the arrows in FIG. 1a indicate the flow directions of the individual phases—to the drain valve V_{LP}, a second CIP feed line 91 can flow into the drain line 9. The second CIP feed line 91 can be opened or closed by a further cleaning fluid valve V_{SF2}.

In the operating state of the centrifugal processing “separating” shown in FIG. 1a, the inlet valve V_{S} in the product feed line 601 is open, so that the product or suspension S can flow continuously into the drum 1 of the separator. Furthermore, the outlet valve V_{LP} in the drain line 9 of the liquid phase LP is open, so that the liquid phase LP, which flows out of separator disk stack 3 and is carried out of drum 1 by the paring disk 8, is continuously discharged from drum 1.

However, the cleaning fluid valves V_{SF1} of the first CIP feed line 602 and V_{SF2} of the second CIP feed line 91 are closed in this operating state.

The solids SP collecting in the area of the largest diameter of the drum 1 in the centrifugal chamber 2 are opened at time intervals by opening the solids discharge openings 10 of the drum 1 by applying a corresponding amount of control fluid to the control system 20, causing the piston slide 11 to move into an opening position, so that the solids SP are emptied/expelled from the drum 1 into the solids catcher 15.

In the present invention, the rinsing and rinse drains described above can be replaced—in accordance with the prior art—by a rinsing or CIP cleaning process in which the rinsing or cleaning liquid is either passed once or several times alternately either through the inlet pipe 6—i.e., rinsing or cleaning takes place in the direction of product flow, see FIG. 1b—or through the drain line 9 and the paring disk 8 of the light phase LP into the rotating and open drum 1 “against the product flow direction”—i.e., rinsing or cleaning takes place against the product flow direction, see FIG. 1c. The rinsing and CIP cleaning process therefore comprises a “forward rinse” and a “backward rinse”.

For the purposes of this document, the term “rinsing” refers to the flow of a rinsing fluid in the product flow direction and/or also against the product flow direction, the rinsing fluid preferably being water. For the purposes of this document, the term “cleaning” or “CIP cleaning” refers to a flow in the product flow direction and/or also against the product flow direction with a cleaning fluid suitable for CIP cleaning, wherein the cleaning fluid can be an alkaline solution or an acid.

Such a rinsing and/or CIP cleaning process preferably takes place after the inlet valve V_{S} has been closed, a closing chamber of the control system 20 has been completely emptied by means of a full drain and the piston slide 11 therefore permanently releases the solids discharge openings 10 for the solids SP.

After a complete emptying of the closing chamber of the control system 20, during which the drum 1 has lost speed, it is then preferably waited until the drum 1 has reached a higher speed again, in particular the operating speed. Then the cleaning fluid valve V_{SF1} is opened for a period of time-preferably for a few seconds- and a rinsing or CIP cleaning fluid is fed through the first CIP feed line 602 into the feed line 61 and further into the inlet pipe 6 into the drum 1.

During this rinsing process according to the invention, the drum 1 remains open. The rinsing or CIP cleaning liquid can thus (see FIG. 1b) flow through the central inlet pipe 6, the distributor channels 7 and the lower area of the drum 1 in order to leave the drum 1 again through the open solids discharge openings 10 for solids SP. After a period of time—preferably a few seconds—this rinsing process, during which the drum 1 has lost speed again, is stopped, i.e., the cleaning fluid valve V_{SF1} is closed.

Then a speed increase, preferably to operating speed, can be waited for and then the cleaning fluid valve V_{SF2} can be opened for a short period of time-preferably a few seconds- and a rinsing or cleaning fluid can be fed into the drum 1 through the drain line 9.

The rinsing or CIP cleaning liquid can thus flow (see FIG. 1c) through the central drain line 9, the paring disk 8, the separating disk stack 3 and the upper area of the drum 1 in order to leave the drum 1 again through the open solids discharge openings 10 for solids SP.

In contrast to the prior art, the flow through the separating disk stack 3 and the upper area of the drum 1 in a rinsing and/or CIP cleaning process according to the invention is preferably no longer against the centrifugal force, but essentially in the direction of the centrifugal force, so that a more intensive flow, i.e., with a higher throughput (volume/time) and thus a higher flow rate of the rinsing or cleaning liquid, is possible.

This higher flow rate results in significantly improved cleaning of the contaminated surfaces of the drum 1 and its internals. It has been shown to be advantageous if the rinsing or CIP cleaning liquid is heated, preferably to a temperature between 40° C. and 90° C., particularly preferably to a temperature between 50° C. and 70° C.

After a period of time-preferably a few seconds—this rinsing, during which the drum 1 has lost speed, can be stopped by closing the cleaning fluid valve V_{SF2}.

Surprisingly, it has been shown that with the described inventive rinsing and/or CIP cleaning process, rinsing emptying of the drum 1, as in the prior art, can generally be dispensed with.

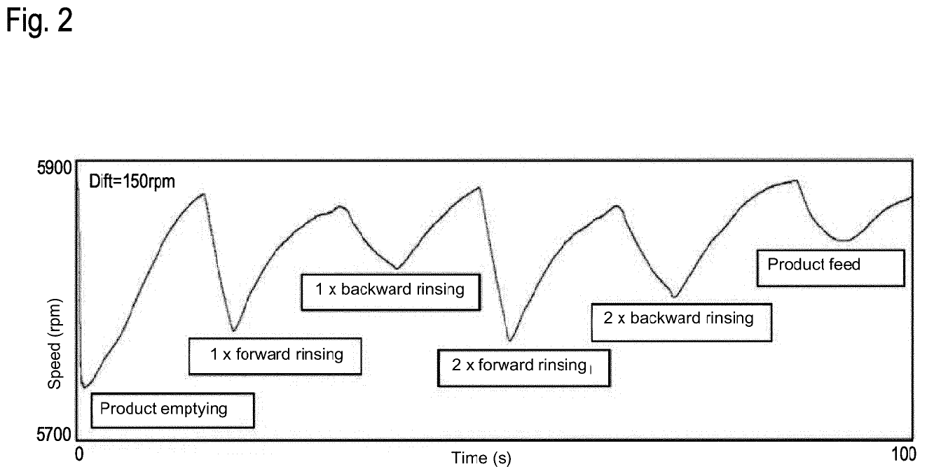

As already described, the drum 1 loses speed during emptying (in this case full emptying) (see FIG. 2).

When rinsing and/or CIP cleaning the open drum 1, drum 1 also loses a significant amount of speed for the same reason.

From the course of the characteristic measured values, for example from the value of the speed drop Δn and the speed of the speed drop Δn/At during a drum emptying, it is possible to draw conclusions about the degree of contamination in the drum 1, i.e., the separating disk stack 3 or the area of the centrifugal chamber 2 in which the solid matter SP collects.

The solids SP are discharged more slowly from a contaminated drum 1, which is reflected in the characteristic of the associated speed drop Δn/At. The course of the measurement curve of the speed drop Δn/At of a clean drum 1 is therefore steeper than that of a dirty drum 1.

If the measured values determined in this way indicate a certain degree of contamination, a corresponding number of rinsing processes can be performed, wherein a rinsing process comprises the forward and backward rinsing described above. In this way, the number of rinsing processes can be individually adapted to the degree of contamination of the drum 1 and the separating disk stack 3.

If these rinsing processes, e.g., with hot water, no longer lead to sufficient cleaning of the drum 1, or more precisely of the separating disk stack 3, the necessary CIP cleaning with cleaning liquids-such as acids and alkalis—is initiated, wherein this is preferably also carried out in the direction of product flow as well as against the direction of product flow, as described above for the rinsing processes.

In contrast to strictly timed CIP cleaning cycles, this method can be used to react as required and save rinsing water, cleaning liquids, energy, and time. During CIP cleaning, the cleaning liquids can be fed through the drum 1 and the separating disk stack 3 in the same way as the rinsing liquid.

If the measured values for speed drop Δn and the speed of the speed drop Δn/At during drum emptying indicate that the drum 1 and the separator disk stack 3 could not be sufficiently cleaned even by CIP cleaning, the separator must be stopped and disassembled for mechanical cleaning. This is also carried out as required and not according to rigid maintenance cycles, which also contributes to the above-mentioned savings and thus to increasing the productivity of the separator and reducing the operating costs of the separator.

These evaluations are preferably carried out with the control program of the control device.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

List of reference signs

| | |
|---|---|
| Drum | 1 |
| Centrifugal chamber | 2 |
| Separating disk stack | 3 |
| Separating disk | 4 |
| Distributor shaft | 5 |
| Inlet pipe | 6 |
| Feed line | 61 |
| Product feed line | 601 |
| First CIP feed line | 602 |
| Distributor channels | 7 |
| Paring disks | 8 |
| Drain line | 9 |
| Second CIP feed line | 91 |
| Solids discharge openings | 10 |
| Piston slide | 11 |
| Hood | 12 |
| Double wall section | 13 |
| Hood interior | 14 |
| Solids catcher | 15 |
| Control system | 20 |
| Outlet | A1, A2 |
| Spindle | X |
| Frame | G |
| Axis of rotation | D |
| Inlet | Z |
| Inlet valve | VS |
| Cleaning fluid valve | VSF1 |
| Cleaning fluid valve | VSF2 |
| Valve | VLP |
| Suspension | S |
| Solid | SP |
| Liquid phase | LP |

1-22. (canceled)

23. A method for centrifugally processing a flowable product with a separator and for rinsing or clean-in-place (CIP) cleaning the separator, the method comprising:
100) providing the separator;
200) carrying out centrifugal processing of a flowable product using the separator, wherein the separator comprises a rotatable drum and a product flow path for the flowable product to be processed in a centrifugal field in the rotatable drum, wherein the flowable product flows through the product flow path in a product flow direction during the centrifugal processing; and
300) interrupting the centrifugal processing, and alternately
a) rinsing or CIP cleaning of at least part of the product paths of the drum of the separator in the product flow direction, and
b) rinsing or CIP cleaning of at least one part of the product paths of the drum entirely or partially in an opposite direction to the product flow direction.

24. The method of claim 23, wherein the separator further comprises:
a centrifugal chamber formed within the rotatable drum;
an inlet into the centrifugal chamber, wherein a product feed line and a first rinsing or CIP feed line open into the inlet, wherein a controllable inlet valve is connected into the product feed line and a controllable cleaning fluid valve is connected into the first CIP feed line;
at least one first outlet for a first product phase, wherein the first outlet opens into a drain line;
at least one second continuously open or discontinuously openable and reclosable outlet for a second product phase; and
a controllable cleaning fluid valve into a second CIP feed line, which opens into the drain line upstream of a drain valve, which is connected into the drain line.

25. The method of claim 24, wherein the second outlet for the second product phase has one or more permanently open nozzles.

26. The method of claim 24, wherein the second outlet for the second product phase has one or more closable and openable solids discharge openings, wherein one or more closing elements for discontinuously opening and closing the solids discharge openings are assigned to the one or more closable and openable solids discharge openings, and wherein at least one control system controls moving the closing element or the closing elements.

27. The method of claim 24, wherein the separator further comprises a control system having a control program with which the method for centrifugally processing a flowable product with a separator and for rinsing or CIP cleaning the separator is controlled.

28. The method of claim 26, wherein
during the rinsing or CIP cleaning of the product paths of the drum of the separator in the product flow direction, a cleaning fluid is passed through the inlet into the rotatable drum and is in each case passed out of the rotatable drum through the open solids discharge openings, and
during rinsing or CIP cleaning of the product paths of the drum of the separator partially in the opposite direction to the product flow direction, a cleaning fluid is passed through the outlet into the drum and is in each case passed out of the drum through open solids discharge openings.

29. The method of claim 23, wherein step 300) is carried out repeatedly for each cleaning operation.

30. The method of claim 26, wherein the rinsing or CIP cleaning process takes place in step after the inlet valve has been closed at an end of step and the solids discharge openings for the solids have been permanently opened or are open.

31. The method of claim 26, wherein after a complete emptying, during which the rotatable drum has lost speed, it is waited until the rotatable drum has reached a higher speed again, wherein a cleaning fluid valve is then opened for a period of time and a rinsing or CIP cleaning fluid is fed through the first CIP feed line into the feed line, and further into a central inlet pipe into the drum, wherein the solids discharge openings of the drum remain open.

32. The method of claim 31, wherein rinsing or CIP cleaning liquid flows through a central inlet pipe, distribution channels and a first of the rotatable drum, from where the rinsing or CIP cleaning liquid flows out of the rotatable drum through the open solids discharge openings for solids.

33. The method of claim 32, wherein after a period of time the rinsing process in step 300) a) or in 300) b), during which the rotatable drum has lost speed again, is stopped by closing the cleaning fluid valve in the first CIP feed line.

34. The method of claim 33, wherein an increase in speed to an operating speed of the separator is waited for and then the controllable cleaning fluid valve, which is connected into the second CIP feed line, is opened for a period of time, which opens into the drain line upstream of the drain valve, which is connected into the drain line, and wherein a further rinsing or CIP cleaning fluid is fed into the rotatable drum through the second CIP feed line and drain line.

35. The method of claim 34, wherein the further rinsing or CIP cleaning liquid flows through the drain line and a paring disk into the rotatable drum, wherein, in the rotatable drum, the further rinsing or CIP cleaning liquid flows through a separating disk stack and a second region of the rotatable drum in order to leave the rotatable drum again through the open solids discharge openings for solids.

36. The method of claim 35, wherein after a period of time the rinsing and cleaning process of step 300) a) or 300) b), during which the rotatable drum has lost speed, is stopped by closing the cleaning fluid valve.

37. The method of claim 32, wherein the rinsing or CIP cleaning liquid has a temperature between 40° C. and 90° C.

38. The method of claim 27, wherein the control program evaluates characteristic measured values, wherein the evaluation of this data in the control system infers a degree of contamination of a separating disk stack or of a region of a centrifugal chamber of the separator in which solid matter collects.

39. The method of claim 38, wherein a number of rinsing or CIP cleaning operations are performed, wherein a rinsing or cleaning operation of the number of rinsing or CIP cleaning operations comprises forward and backward rinsing in each when a value of a speed drop of the rotatable drum and a speed of the speed drop of the rotatable drum during emptying the rotatable drum emptying indicate a defined degree of contamination of the separator.

40. The method of claim 39, wherein when the rinsing or CIP cleaning in steps 300) a) and 300) b) are no longer sufficiently cleaning the separator, a CIP cleaning with cleaning liquids is initiated.

41. The method of claim 40, wherein the separator is stopped and disassembled for mechanical cleaning when the measured values for speed drop and the speed of the speed drop during a drum emptying indicate that the CIP cleaning has no longer achieved sufficient cleaning.

42. A separator comprising for processing a product:
a rotatable drum;
a product flow path configured for a flowable product to be processed in a centrifugal field in the rotatable drum, wherein the product flows through the product flow path in a product flow direction during centrifugal processing;
a centrifugal chamber inside the rotatable drum;
an inlet into the centrifugal chamber, wherein a product feed line and a first rinsing or clean-in-place (CIP) feed line open into the inlet, wherein an inlet valve is connected into the product feed line and a cleaning fluid valve is connected into the first CIP feed line;
ili. at least one first outlet for a first product phase, wherein the at least one first outlet opens into a drain line;
iv. at least one second continuously open or discontinuously openable and reclosable outlet for a second solids-type product phase, and
v. a controllable cleaning fluid valve which is connected into a second CIP feed line, which opens into the drain line upstream of a drain valve which is connected into the drain line; and
vi. a control device with a control program, wherein the control device executing the control program causes the control device to
carry out centrifugal processing of a flowable product using the separator, wherein the separator comprises a rotatable drum and a product flow path for the flowable product to be processed in a centrifugal field in the rotatable drum, wherein the product flows through the product flow path in a product flow direction during the centrifugal processing; and
interrupt the centrifugal processing, and alternately
a) rinsing or CIP cleaning of at least part of the product paths of the drum of the separator in the product flow direction, and
b) rinsing or CIP cleaning of at least one part of the product paths of the drum entirely or partially in an opposite direction to the product flow direction.

43. The separator of claim 42, wherein the at least one second continuously open or discontinuously openable and reclosable outlet for the second product phase has one or more permanently open nozzles.

44. The separator of claim 42, wherein the at least one second continuously open or discontinuously openable and reclosable outlet for the second product phase has one or more closable and openable solids discharge openings, wherein one or more closing elements for discontinuously opening and closing the solids discharge openings are assigned to the one or more closable and openable solids discharge openings, wherein the separator further comprises at least one control system configured to control movement of the closing element or elements.
